(19) United States
(12) Patent Application Publication
(10) Pub. No.: US 2010/0188070 A1
(43) Pub. Date: Jul. 29, 2010

(54) METHOD AND DEVICE FOR MEASURING A LEVEL OF AN ELECTRIC MEASUREMENT VARIABLE THAT CAN BE CHANGED OVER TIME

(76) Inventors: Klaus-Peter Linzmaier, Winterbach (DE); Axel Voges, Wendlingen (DE)

Correspondence Address: STAAS & HALSEY LLP, SUITE 700, 1201 NEW YORK AVENUE, N.W., WASHINGTON, DC, 20005, US

(21) Appl. No.: 12/450,772

(22) PCT Filed: Apr. 7, 2008
(86) PCT No.: PCT/EP2008/054150

§ 371 Date: Mar. 15, 2010

(30) Foreign Application Priority Data
Apr. 13, 2007 (DE) 10 2007 017 895.8

(51) Int. Cl. G01D 1/14

(52) U.S. Cl. 324/76.13

(57) ABSTRACT

A method measures a level of an electric measurement variable that can be changed over time, particularly an electric voltage or an electric current. A measurement signal of the measurement variable is differentiated and a current amplitude value of the differentiated measurement variable is determined. Through the iterative approximation of a comparison value to the current amplitude value a level value of the measurement variable is determined.

### CROSS REFERENCE TO RELATED APPLICATIONS

This application is based on and hereby claims priority to PCT Application No. PCT/EP2008/054150 filed on Apr. 7, 2008 and DE Application No. 10 2007 017 895.8 filed on Apr. 13, 2007, the contents of which are hereby incorporated by reference.

### BACKGROUND OF THE INVENTION

The invention relates to a method and a device for measuring a level of a temporally changeable electrical measurement variable.

In communications and telecommunications technology it is known to detect and visualize levels of an electrical measurement variable, e.g. of a power, of an electrical voltage or of an electric current. In this case, a level hereinafter denotes a logarithmic variable defined by the logarithmized ratio of the respective electrical measurement variable to an associated reference value, e.g. for a reception level of a reception power in dBm with a reference value of P₀=1 mW.

Thus, by way of example, in the case of a device for transmitting information by optical waveguides, light is coupled in at one end of the optical waveguide by a transmitter, the light being passed through the optical waveguide as far as the other end thereof and being received and coupled out there by a corresponding receiver. Owing, for example, to soiling of the optical waveguide or optical waveguides and/or as a result of high attenuations in the optical waveguide, it is of importance to detect a reception level at least at the receiving end. As the reception level, by way of example, a reception power is determined in a manner dependent on an output voltage present at the receiver. In this case, the reception level in the case of transmission via optical waveguides can lie in a range of a plurality of decades e.g. from −3 dBm to −30 dBm for various wavelengths, e.g. 660 nm, 850 nm or 1300 nm.

In order to detect and visualize electrical levels it is known to use a so-called peak value rectifier, that determines the peak value of a temporally changeable electrical measurement variable and displays it, if appropriate. In this case, the peak value rectifier is conventionally formed from a plurality of operational amplifiers connected in series. What is disadvantageous in this case is that the peak value determined is dependent on the frequency considered and on the duty ratio. As a result, level detection and level assessment are very inaccurate and possible only to a limited extent.

DE 100 63 102 A1 discloses by way of example, an arrangement and measurement of internal voltages in an integrated semiconductor device wherein a comparison unit is provided which compares the internal voltage to be measured with an externally supplied reference voltage.

### SUMMARY

Therefore, one possible object is specifying a method and a device for measuring a level of an electrical measurement variable wherein a level value can be determined as accurately and reliably as possible in conjunction with simple measurement outlay.

The inventors propose a method for measuring a level of a temporally changeable electrical measurement variable, in particular of an electrical voltage or of an electric current. A measurement signal of the measurement variable is differentiated and an instantaneous amplitude value of the differentiated measurement signal is determined, wherein a level value of the measurement variable is determined by iterative approximation of a comparison value to the instantaneous amplitude value. As a result of an iterative approximation, the level value to be determined e.g. a voltage value, can be determined very accurately and in a wide range of frequency and duty ratio. For this purpose, the iterative approximation is carried out using analog circuit technology, e.g. on the basis of a comparator.

Expediently, by the comparator, the instantaneous amplitude value is detected and compared with a predefinable comparison value.

In this case, the differentiated measurement signal has the form of a measurement pulse, and an amplitude value of the differentiated measurement signal is understood here and hereinafter to mean a peak value of the measurement pulse. In other words, in the case of sequence of measurement pulses, each measurement pulse represents an amplitude.

The differentiation of the measurement signal is particularly advantageous since the switching edges upon the signal change can thereby be detected significantly more reliably. This ensures that measurement sensitivity and measurement accuracy are increased by comparison with non-differentiating methods, in particular by comparison with methods that detect temporal average values of the measurement signal over relatively long time intervals. The differentiation of the measurement signal has a positive effect particularly when detecting a signal change after a relatively long continuous signal. This is because temporally averaging measurement methods are not sensitive to such a signal change since after the continuous signal, the temporal average value remains virtually unchanged as a result of the signal change. This has an effect particularly in the case of so-called NRZ-modulated measurement signals (NRZ=non-return-to-zero), since an occurrence of relatively long continuous signals is not prevented in this case.

In one possible embodiment, in the case of a comparator embodied as a comparison unit, as the comparison value, a reference value or the preceding level value of the measurement variable is predefined and the comparison value is incremented by a predefinable increment if the instantaneous amplitude value exceeds the predefined reference value or the preceding level value, or the comparison value is maintained if the instantaneous amplitude value falls below the predefined reference value or the preceding level value.

The increment is expediently constant, since through the use of a differentiator instead of a measurement value the amplitude value thereof rather than the pulse length is detected.

The comparison value is preferably initialized with an initial value of zero. Furthermore the comparison value tends toward zero in the absence of a present measurement value of the electrical measurement variable within a predefinable time.

In one development, the level value determined can be output optically. Moreover, on the basis of the level value determined, e.g. a voltage level, in the case of a known transmission line an associated power level can be determined.

In addition, for a differentiated assessment of the quality of the level value determined, the latter can be analyzed and assessed on the basis of a level range delimited by two threshold values. For this purpose, a window comparator formed from two further comparators can be provided, which monitors the level value determined with regard to a value range delimited by two threshold values being exceeded or undershot. A first, lower threshold value and a second, upper threshold value are predefined in this case. If the level value determined exceeds the upper threshold value and thus the value range, then a corresponding output signal e.g. for driving an optical display, can be generated. Likewise, in the event of the lower threshold value and thus the value range being undershot, a further output signal, e.g. for driving a further optical display, can be generated.

With regard to the device for measuring a level of a temporally changeable electrical measurement variable, this device comprises at least a differentiator for differentiating a measurement signal of the measurement variable and determining an instantaneous amplitude value of the differentiated measurement signal, and also a comparator connected downstream of the differentiator, and an amplifier, which together act as an incrementer in such a way that a level value of the measurement variable can be determined by iterative approximation of a comparison value to the instantaneous amplitude value.

Depending on the predefinition, in this case the comparator can be embodied as a comparison unit that compares the instantaneous amplitude value of the measurement variable with the comparison value.

For outputting the level value determined, an optical display can be connected downstream of the incrementer. Depending on the predefinition and embodiment of the comparator, the display can be embodied as a single-color light-emitting diode display or as a multicolor light-emitting diode display, in particular a two-color light-emitting diode display. Moreover, the display can be embodied as a single-color fiber-optic display or as a multicolor fiber-optic display, in particular a two-color fiber-optic display.

In order to assess the quality of the level value determined, a window comparator formed from two comparators can be connected downstream of the incrementer, the window comparator comparing the level value determined with a value range delimited by two threshold values.

In a preferred embodiment, the differentiator, the comparator and the amplifier and, if appropriate, the window comparator are embodied using analog circuit technology.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 schematically shows a device for measuring a level of an electrical measurement variable for an optical transmission system,

FIG. 2 schematically shows one possible embodiment for a circuit arrangement of the device for measuring the level,

FIG. 3 schematically shows a supplementation of the circuit arrangement in accordance with FIG. 2 for assessing the quality of the level determined, and

FIG. 4 shows a voltage-power diagram.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

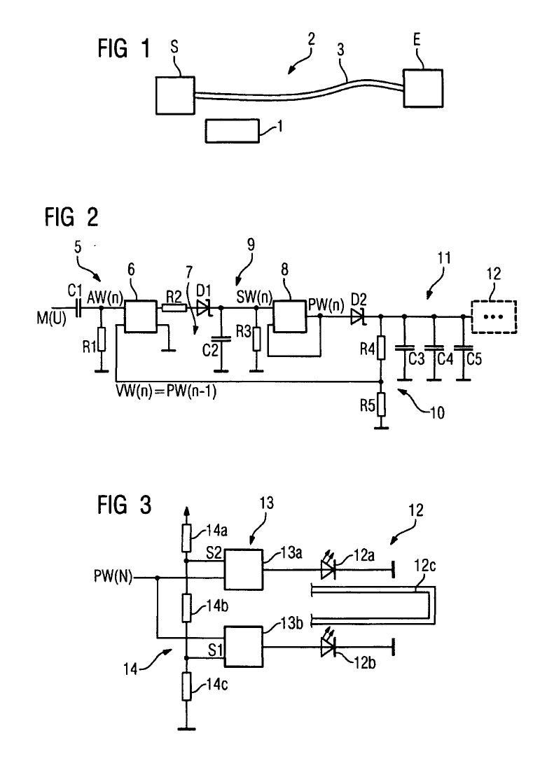

FIG. 1 shows a measuring device 1 for measuring a level value PW of a temporally changeable electrical measurement variable M(U), in particular of an electrical voltage U. The electrical measurement variable M(U) is designated hereinafter by M for short. Alternatively, a power P or an electric current I can be detected as the electrical measurement variable M.

The measurement variable M to be detected and determined is an electrical voltage U, in particular, which for example in the case of an optical transmission system 2 comprising an optical waveguide 3 used as transmission medium, in particular quartz glass fibers, describes as the output voltage at a transmitter S, as output voltage describes a light signal S to be coupled into the optical waveguide 3, the light signal being received and coupled in at the other end of the optical waveguide 3 at a receiver E with a reception level e.g. a reception power level Lₚ.

The measuring device 1 is illustrated in greater detail in FIG. 2. In this case, as analog measurement variable M, the output voltage U of the receiver E is fed to a differentiator 5 formed from a capacitor C1 and a resistor R1. The output of the differentiator 5 is connected to an input of a comparator 6. An amplitude value AW(n) of the output voltage U is generated as the output signal of the differentiator 5, which is fed to the comparator 6 as input signal. The comparator 6 is embodied as a comparison unit to which a comparison value VW(n), a voltage reference value in the exemplary embodiment, is fed as a further input signal. Connected downstream of the comparator 6 are a level converter 7, formed from a resistor R2, a diode D1, a capacitor C2 and a resistor R3, and an amplifier 8, which act as an incrementer 9 in such a way that a level value PW(n) of the measurement variable M is determined at the output of the measuring device 1 by iterative approximation of the comparison value VW(n) present at the comparator 6 to the instantaneous amplitude value AW(n). In this case, the comparison value VW(n) is determined on the basis of the preceding level value PW(n−1) or a predefinable reference value, the initial value of the comparison value VW(n) being equal to zero. For this purpose, a diode D2 and a resistor element 10 formed from the resistors R4, R5, and a capacitor chain 11 formed from the capacitors C3 to C5 are connected downstream of the amplifier 8.

By comparison with conventional digital peak value rectifiers, the measuring device 1, as shown in FIG. 2, is embodied using analog active circuit technology, that is to say the differentiator 5, the comparator 6 and the amplifier 8 are embodied using analog circuit technology.

The method of operation of the measuring device 1 is described in greater detail below. The comparator 6 compares the instantaneous amplitude value AW(n) with the comparison value VW(n). If the amplitude value AW(n) is less than or equal to the comparison value VW(n)(where AW(n)<=VW(n)), then no output signal AS is generated at the comparator 6 and the next comparison value VW(n+1) is formed by the preceding level value PW(n). In other words, the comparison value VW(n) is maintained as the next comparison value VW(n+1). By contrast, if the instantaneous amplitude value AW(n) exceeds the comparison value VW(n), then an output signal AS is generated and the capacitor C2 connected downstream of the comparator 6 is charged by an increment formed from the difference between AW(n) and VW(n) to a voltage value SW(n) approximately corresponding to the amplitude value AW(n). In this case, the capacitor C2 is charged further by the increment with each subsequent measurement value pulse with rising instantaneous amplitude value AW(n) the increment being constant. If the comparison value VW(n) is equal to the subsequent amplitude value AW(n+1) or greater than the latter, then no comparator output signal is generated, with the result that the capacitor C2 is discharged within a predefinable time and the level value PW(n) tends to zero until a present measurement signal has an amplitude value AW(n) which is greater than the comparison value VW(n).

The voltage value SW(n) determined is subsequently amplified and converted into the level value PW(n), which can be optionally output optically depending on the embodiment of the measuring device 1. For this purpose, an optical display 12 can be connected downstream of the incrementer 9. In this case, the optical display 12 can be embodied as a single-color light-emitting diode display or as a two-color light-emitting diode display, in which case the voltage value SW determined iteratively by the incrementer 9 is applicable as a measure of the level value PW(n) and the optical display 12 reproduces the rising or falling value of the level value PW(n) for example by driving a plurality of light-emitting diodes corresponding to the rising or falling value, respectively.

Moreover, the optical display 12 can be embodied as a single-color light-emitting diode display or as a multicolor light-emitting diode display, in which case the voltage value SW(n) determined iteratively by the incrementer 9 is applicable as a measure of the level value PW(n) and the optical display 12 changes brightness or color depending on the level value PW(n).

In a further alternative exemplary embodiment, the optical display 12 can be embodied as a single-color light-emitting diode display. The optical display 12 lights up when the level value PW(n) determined lies in the good range. Depending on the measurement variable determined, the display 12 can illuminate, for example, if the level value PW(n) determined lies above a predefined value, e.g. a voltage value U of 240 mV. In this case, in order to easily identify a so-called “good” level value PW(n), the optical display 12 will light up green, for example. In order to identify a so-called “poor” or “critical” level value PW(n) the optical display 12 can have a corresponding other luminous color, e.g. red or orange or yellow. In this case, the display 12 in this exemplary embodiment is embodied as a single-color light-emitting diode display or a single-color fiber-optic display.

In a further alternative exemplary embodiment, the optical display 12 can be embodied as a multicolor display, e.g. a two- or three-color light-emitting diode display. In this case, the display 12 lights up in different colors depending on the level value PW(n) determined.

Expediently, the optical display 12 lights up red if the level value PW(n) lies in the “poor” range, yellow if the level value PW(n) lies in the “critical” range, and green if the level value PW(n) lies in the “good” range.

In this case, an optical display 12 embodied as a three-color display can advantageously be formed from two different-colored light-emitting diodes 12a and 12b and an optical waveguide 12c, the light-emitting diodes 12a and 12b being driven by a window comparator 13, as is illustrated in greater detail in FIG. 3.

By a voltage divider 14 comprising three resistors 14a, 14b and 14c, two threshold value S1 and S2 are formed as comparison values of the window comparator 13, which comprises two individual comparators 13a and 13b. The threshold values S1 and S2 are, by way of example, 120 mV (=lower threshold value S1) and 240 mV (=upper threshold value S2). The reception level value PW(n) determined iteratively is compared with the upper threshold value S2 by one comparator 13a and with the lower threshold value S1 by the other comparator 13b. If the level value PW(n) determined is less than both threshold values S1 and S2, only the light-emitting diode 12a that lights up red is driven, that is to say that the level value PW(n) determined lies in the “critical” range below 120 mV. If the level value PW(n) determined is greater than both threshold values S1 and S2, only the light-emitting diode 12b that lights up green is driven, that is to say that the level value PW(n) determined lies in the “good” range above 240 mV. The third color (=yellow) is generated in this exemplary embodiment by additive color mixing with the simultaneous driving of both light-emitting diodes 12a and 12b if the level value PW(n) is greater than the lower threshold value S1 (e.g. where PW(n)>120 mV) and less than the upper threshold value S2 (e.g. where PW(n)<240 W) and thus lies within the value range. In this case, the light emitted by the two light-emitting diodes 12a and 12b is passed to the outer wall of the apparatus by the optical waveguide 12c. In order to achieve sufficient color mixing the optical waveguide 12c comprises diffuse components.

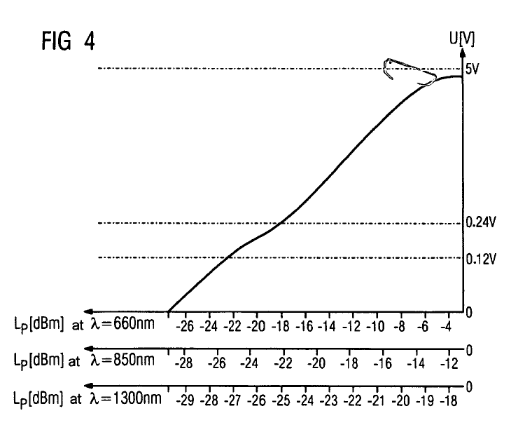

FIG. 4 shows a diagram from which, by way of example, the transmission quality of the transmitted signal of the measurement variable M can be determined on the basis of the level value PW(n) determined for the voltage U and a reception power level Lₚ assigned to this voltage level value PW(n). Depending on the influencing variables of the optical waveguide 3 such as e.g. intensity of the transmission power, ambient temperature of the optical transmitter S and of the receiver E, the attenuation of the transmission path, the transmission rate used, the level value PW(n) for the voltage U is determined by iterative approximation by the method described above. In this case, the received level value PW(n) can be classified into the following three level ranges:

| | |
|---|---|
| Level value PW in the normal range | 5 V > U > 240 mV, |
| Level value PW in the critical range | 120 mV <= U <= 240 mV |
| and | |
| Level value PW in the poor range | U < 120 mV. |

For this purpose, the optical display 12 can display for example the “good” range by a corresponding number of green light-emitting diodes 12b and the “poor” range by a corresponding number of red light-emitting diodes 12a in which case the “critical” range is generated by color mixing in the optical waveguide 12c and can be displayed.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-17. (canceled)

18. A method for measuring a level of a temporally changeable electrical measurement variable, comprising:
differentiating a measurement signal of the measurement variable to produce a differentiated measurement signal;
determining an instantaneous amplitude value of the differentiated measurement signal; and
determining a level value of the measurement variable by iterative approximation of a comparison value to the instantaneous amplitude value.

19. The method as claimed in claim 18, wherein the iterative approximation comprises comparing the instantaneous amplitude value with a predefinable comparison value.

20. The method as claimed in claim 19, wherein
a reference value or a preceding level value of the measurement variable is predefined as the comparison value, and
the comparison value is incremented by a predefinable increment if the instantaneous amplitude value exceeds the predefined reference value or the preceding level value, or the comparison value is maintained if the instantaneous amplitude value is below the predefined reference value or the preceding level value.

21. The method as claimed in claim 20, wherein the increment is defined and maintained constant throughout the method.

22. The method as claimed in claim 18, wherein the comparison value is initially set to zero.

23. The method as claimed in claim 20, wherein the comparison value is decreased toward zero if the measurement signal of the measurement variable is absent for a predefinable time.

24. The method as claimed in claim 18, wherein the level value is output optically.

25. The method as claimed in any one of claims 18 to 24, wherein the level value is analyzed and assessed based on a level range delimited by two threshold values.

26. A device for measuring a level of a temporally changeable electrical measurement variable, comprising:
a differentiator to differentiate a measurement signal of the measurement variable and produce a differentiated measurement signal, and to determine an instantaneous amplitude value of the differentiated measurement signal; and
an incrementer connected downstream from the differentiator, the incrementer comprising an amplifier and a comparator, which together act to determine a level value of the measurement variable by iterative approximation of a comparison value to the instantaneous amplitude value.

27. The device as claimed in claim 26, wherein the comparator is a comparison unit that compares the instantaneous amplitude value with the comparison value.

28. The device as claimed in claim 26, further comprising a window comparator connected downstream from the incrementer, the window comparator comparing the level value with a value range delimited by two threshold values.

29. The device as claimed in claim 26, further comprising an optical display connected downstream from the incrementer.

30. The device as claimed in claim 29, wherein the optical display is a single-color light-emitting diode display or a multicolor light-emitting diode display.

31. The device as claimed in claim 29, wherein the optical display is a single-color fiber-optic display or a multicolor fiber-optic display.

32. The device as claimed in claim 30, wherein
the optical display is a three-color display, and
two colors of the three-color display are produced by two different-colored light-emitting diodes and a third color of the three-color display is produced by light mixing from luminous colors of the light-emitting diodes in an optical waveguide.

33. The device as claimed in claim 32, wherein the light mixing is produced from diffuse components in the optical waveguide.

34. The device as claimed in any one of claims 26 to 33, wherein the differentiator, the comparator and the amplifier are formed from analog circuits.

35. A method for measuring a level of a temporally changeable electrical measurement variable, comprising:
differentiating a measurement signal of the measurement variable to produce a differentiated measurement signal;
determining an instantaneous amplitude value of the differentiated measurement signal;
determining a level value of the measurement variable by iteratively approximating a comparison value to the instantaneous amplitude value by a process comprising:
assuming an initial comparison value;
if the instantaneous amplitude value exceeds the comparison value, incrementing the comparison value;
if the instantaneous amplitude value is below the comparison value, maintaining the comparison value; and
if the measurement signal of the measurement variable is absent, decrementing the comparison value; and
displaying the level value.
